(19) United States
(12) Patent Application Publication
(10) Pub. No.: US 2015/0068831 A1
(43) Pub. Date: Mar. 12, 2015

(54) DRIVE UNIT FOR A HYBRID VEHICLE

(71) Applicant: Philipp Ebner, Graz (AT)

(72) Inventor: Philipp Ebner, Graz (AT)

(73) Assignee: Magna Powertrain AG & Co. KG, Lannach (AT)

(21) Appl. No.: 14/113,589

(22) PCT Filed: Feb. 29, 2012
(86) PCT No.: PCT/EP2012/053388

§ 371 Date: Apr. 25, 2014

(30) Foreign Application Priority Data
Apr. 28, 2011 (DE) 10 2011 018 861.4

(51) Int. Cl. B60K 6/48; B60K 6/365; F16H 48/06; B60K 6/52

(52) U.S. Cl. CPC B60K 6/48; B60K 6/52; B60K 6/365; F16H 48/06; Y10S 903/902
USPC 180/243; 180/65.25; 903/902

(57) ABSTRACT

A drive unit for a hybrid vehicle which has a front axle and a rear axle, having an internal combustion engine, which is arranged in the region of the front axle, for driving at least the rear axle, an electric machine for driving the front axle, and a front axle differential which has an input member for receiving a drive power output from the electric machine, and two output members for coupling to a respective wheel of the front axle. The electric machine and the front axle differential are arranged along the front axle on opposed sides of the internal combustion engine, the electric machine being coupled in drive terms to the input member of the front axle differential via a connecting shaft which is guided through an oil sump of the internal combustion engine.

### CROSS-REFERENCE TO RELATED APPLICATIONS

This application is a U.S. National Stage of International Application No. PCT/EP2012/053388 filed Feb. 29, 2012 which claims the benefit of and priority to German Application No. DE 102011018861.4 filed Apr. 28, 2011. The entire disclosure of each of the above applications is incorporated herein by reference.

### TECHNICAL FIELD

The present invention relates to a drive unit for a hybrid vehicle which has a front axle and a rear axle, having an internal combustion engine, which is arranged in the region of the front axle, for driving at least the rear axle, and an electric machine for driving the front axle.

### BACKGROUND

Hybrid drive trains for motor vehicles which use both an internal combustion engine and an electric machine as drive source are distinguished by a high degree of efficiency and the possibility to save fuel. A drive train of a vehicle having an internal combustion engine and rear axle drive can be extended to produce a hybrid drive train with all wheel drive, by the front axle being driven by way of an electric machine. This can take place in principle via a front axle differential which has an input member for receiving a drive power output from the electric motor and two output members for coupling to a respective wheel of the front axle. Depending on the application, a front axle differential of this type can be configured as a bevel gear differential or as a planetary gear differential. If, in particular, the internal combustion engine is configured as a front-mounted longitudinal engine, that is to say a crankshaft of the internal combustion engine is oriented parallel to the vehicle longitudinal axis, the only accommodation options in practice for the front axle differential and the electric machine exist laterally next to the internal combustion engine as viewed in the direction of the vehicle longitudinal axis. On account of the limited installation space, only an electric machine of small dimensions with a correspondingly low power output can be used. This restricts the driving performance and the fuel efficiency of the hybrid vehicle.

### SUMMARY

It is an object of the invention to make an effective drive of the front axle by way of an electric machine possible in a hybrid vehicle having an internal combustion engine which is arranged in the region of the front axle.

The object is achieved by way of a drive unit for a hybrid vehicle which has a front axle and a rear axle, having an internal combustion engine, which is arranged in the region of the front axle, for driving at least the rear axle, an electric machine for driving the front axle, and a front axle differential which has an input member for receiving a drive power output from the electric machine, and two output members for coupling to a respective wheel of the front axle, the electric machine and the front axle differential being arranged along the front axle on opposed sides of the internal combustion engine, and the electric machine being coupled in drive terms to the input member of the front axle differential via a connecting shaft which is guided through an oil sump of the internal combustion engine.

In accordance with the invention, the electric machine and the front axle differential are arranged along the front axle on opposed sides of the internal combustion engine, and the electric machine is coupled in drive terms to the input member of the front axle differential via a connecting shaft which is guided through an oil sump of the internal combustion engine.

By virtue of the fact that the electric machine and the front axle differential are arranged on different sides of the internal combustion engine, more space is available overall for accommodating the electric machine, with the result that an electric machine with a correspondingly higher power output can be used. The components which are required for the electromechanical driving of the front axle are therefore divided up to the accommodation space which is available on both sides of the internal combustion engine, which results in improved space utilization overall. On account of the coupling of the electric machine and the front axle differential by means of the connecting shaft which is guided through the oil sump, complicated repositioning or reconstruction of the internal combustion engine is not necessary. Overall, the invention therefore makes simple integration possible of an electromechanical front axle drive into an existing motor vehicle with a front-mounted longitudinal internal combustion engine and rear axle drive.

Developments of the invention are specified in the dependent claims, the description and the appended drawings.

The connecting shaft is preferably guided through a passage which is provided in the oil sump. In this way, complicated seals and undesired splash effects are avoided. Depending on the application, the passage can be a channel-like leadthrough through the oil sump or else a cutout which is open toward one side of the oil sump, for example the underside.

The connecting shaft can be configured as a hollow shaft, through which a lateral shaft is guided which extends from one of the output members of the front axle differential to the associated wheel of the front axle. The connecting shaft can therefore be arranged coaxially with respect to the front axle differential, which results in a particularly space-saving overall arrangement.

Furthermore, the drive unit can comprise a clutch for selectively disengaging the electric machine from the input member of the front axle differential, in order to disengage the electric machine and/or a part of an associated step-down gear mechanism from the remaining drive if required, for example if a predefined vehicle speed is exceeded. As a result, for example, drag losses and an excessively high rotational speed of the electric machine can be avoided. A separating clutch of this type is preferably arranged between the electric machine and the connecting shaft or between the connecting shaft and the front axle differential. As an alternative to this, a separating clutch can be provided between one of the two output members of the front axle differential and the associated front wheel, in particular on a lateral shaft which extends from the relevant output member to the associated wheel of the front axle, as a result of which decoupling of the electric machine from the remaining drive can likewise be brought about. Depending on the application, the clutch can be active in a frictional or positively locking manner.

In accordance with one embodiment of the invention, a drive shaft of the electric machine is arranged coaxially with respect to the connecting shaft and is configured, in particular, as a hollow shaft. This makes a particularly space-saving construction of the drive unit possible, it being possible for one of the lateral shafts to be guided through the drive shaft. The drive shaft can also be configured in one piece with the connecting shaft.

Furthermore, the drive unit can comprise an, in particular two-stage, step-down gear mechanism which is configured for stepping down a rotation of the input member of the front axle differential relative to a rotor of the electric machine. This makes the use of an electric machine with a comparatively high rotational speed possible, which electric machine can be of relatively small dimensions for a predefined power output.

The step-down gear mechanism can comprise at least one planetary gear mechanism which is, in particular, coaxial with respect to the connecting shaft and comprises a first member for coupling to the electric machine, a second member for coupling to the input member of the front axle differential and a third, fixed member. In relation to the installation space, a planetary gear mechanism makes a relatively great transmission ratio and the transmission of comparatively high torques possible. It is also advantageous that the input and the output lie coaxially with respect to one another in a planetary gear mechanism. In accordance with one refinement of the invention, the planetary gear mechanism comprises a fixed internal gear, for example an internal gear which is pressed into a housing, a planetary carrier with planetary gears which are mounted movably thereon, and a sun gear, the drive preferably taking place via the sun gear and the output preferably taking place via the planetary carrier.

The planetary gear mechanism is preferably arranged on that side of the internal combustion engine, on which the front axle differential is arranged. More space for accommodating the electric machine therefore remains on the opposite side of the internal combustion engine.

The second member of the planetary gear mechanism can be configured in one piece with the input member of the front axle differential. For example, a planetary carrier of the planetary gear mechanism can be integrated into a differential cage of the front axle differential. The required installation space can be reduced further by way of a single-piece configuration of this kind of the second member of the planetary gear mechanism with the input member of the front axle differential.

In accordance with one refinement of the invention, the planetary gear mechanism comprises a sun gear, an internal gear and a planetary carrier with a plurality of rotatably mounted planetary gears, the planetary gears having a first toothing section which meshes with the sun gear and a second toothing section which meshes with the internal gear, the first toothing section having a greater diameter than the second toothing section. A planetary gear mechanism of this type is also called a “multi-step planetary gear mechanism”. In principle, instead of a greater diameter, the first toothing section could also have a greater number of teeth than the second toothing section. In a refinement of this type, the connecting shaft can drive the larger planetary gears via the sun gear, whereas the smaller planetary gears are supported on the fixed internal gear. This therefore results in two step-down stages which are arranged one behind another, with the result that overall a greater step-down ratio can be achieved than in the case of a single planetary gear mechanism and an electric machine which correspondingly rotates more rapidly can be used.

In accordance with a further embodiment of the invention, the step-down gear mechanism comprises two single-stage planetary gear mechanisms which are arranged on opposed sides of the internal combustion engine and form respective step-down gear mechanisms which are connected one behind another. In this refinement, the step-down gear mechanism is divided up along the front axle to the two sides of the internal combustion engine, which can be advantageous with regard to space utilization in certain application situations.

In accordance with a further embodiment of the invention, a drive shaft of the electric machine is offset in parallel relative to the connecting shaft, an offset drive forming a step-down gear mechanism for coupling the drive shaft to the connecting shaft. The use of an offset drive or offset gear mechanism results in the possibility of positioning the electric machine at a favorable location in the front engine compartment.

In particular, the offset drive can comprise a spur gear set with at least one input spur gear which is coupled or can be coupled to the electric machine and an output spur gear which is coupled or can be coupled to the connecting shaft. Here, the transmission ratio of a step-down gear mechanism of this type results from the difference in the diameters or numbers of teeth of the input spur gear with respect to the output spur gear. In particular, the offset drive can form a first step-down stage which is followed by a second step-down stage in the form of a planetary gear mechanism.

The input spur gear and the output spur gear of the offset drive preferably mesh with at least one intermediate spur gear, in order to make a sufficiently great spacing between the lateral shaft and the drive shaft of the electric machine possible. In principle, this spacing could also be bridged by means of a chain drive or belt drive.

Furthermore, the drive unit can comprise a shiftable clutch, in order to couple the output spur gear of the offset drive selectively to the connecting shaft. For example, an output spur gear of the offset drive can be coupled selectively to the connecting shaft which is guided through the oil sump to the front axle differential, for example by means of a slider sleeve. As an alternative to this, a switchable clutch can be provided between a drive shaft of the electric machine and the input spur gear of the offset drive or between the connecting shaft and the input member of the front axle differential. The electric machine can be decoupled from the front axle as required by way of the shiftable clutch.

In accordance with a further embodiment of the invention, a drive shaft of the electric machine is oriented at an angle which differs from 180° with respect to the connecting shaft, an angle drive forming a step-down gear mechanism for coupling the drive shaft to the connecting shaft. For example, the drive shaft of the electric machine can be oriented at right angles to the connecting shaft. The angle drive can be configured, in particular, as a hypoid drive. For example, this makes an arrangement of the electric machine possible in the longitudinal direction parallel to an internal combustion engine which is configured as a front-mounted longitudinal engine or an arrangement of the electric machine with a vertically oriented axis, which can be advantageous in certain application situations.

### DRAWINGS

The invention will be described in the following text by way of example with reference to the drawings, in which:

FIG. 1 is a sectional illustration of a drive unit in accordance with a first embodiment of the invention,

FIG. 2 is a sectional illustration of a drive unit in accordance with a second embodiment of the invention,

FIG. 3 is a sectional illustration of a drive unit in accordance with a third embodiment of the invention, and

FIG. 4 is a sectional illustration of a drive unit in accordance with a fourth embodiment of the invention.

### DESCRIPTION

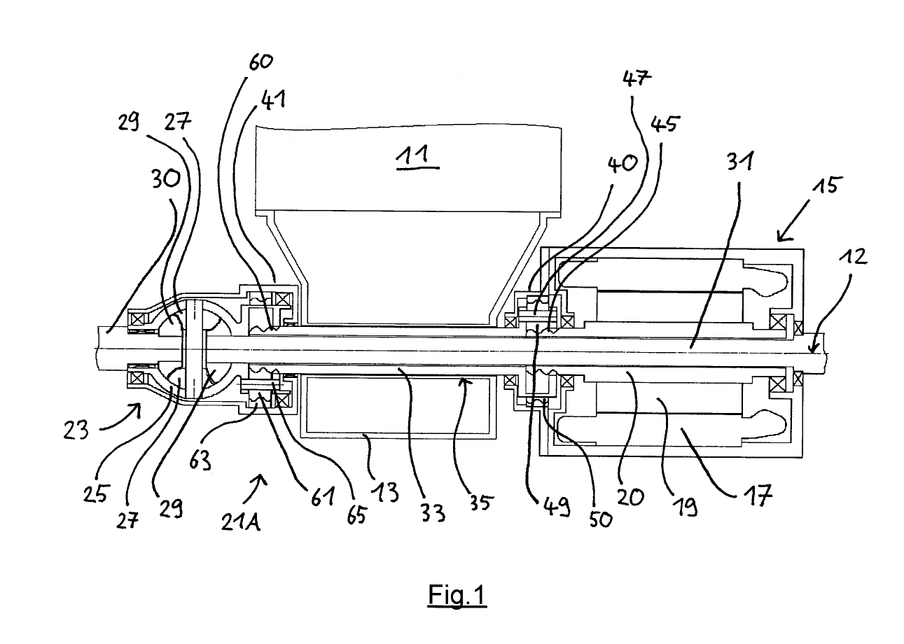

The drive unit, illustrated in FIG. 1, for a hybrid vehicle comprises an internal combustion engine 11 which is configured as a front-mounted longitudinal engine which is arranged in the region of a front axle 12 of the vehicle and drives a rear axle of the vehicle via a drive train (not illustrated). An oil sump 13 is provided on the underside of the internal combustion engine 11.

Furthermore, the drive unit comprises an electric machine 15 with a stator 17 and a rotor 19 which can be rotated with respect to the stator 17 and is seated fixedly on a drive shaft 20 of the electric machine 15 so as to rotate with it.

A front axle differential 23 has a differential cage 25, on which bevel gears 27 are mounted rotatably which mesh with bevel gears 29 which are coupled in drive terms to a left-hand lateral shaft 30 and a right-hand lateral shaft 31. The left-hand lateral shaft 30 and the right-hand lateral shaft 31 are coupled to a respective wheel (not illustrated) of the front axle 12, with the result that a drive power output which is introduced into the differential cage 25 can be transmitted with the rotational speed equalization to the two front wheels. The drive shaft 20 of the electric machine 15 is coupled via a step-down gear mechanism 21A and a connecting shaft 33 to the differential cage 25 of the front axle differential 23, in order accordingly to transmit an electric drive power output to the wheels of the front axle 12.

As is apparent from FIG. 1, the electric machine 15 and the front axle differential 23 are arranged on opposed sides of the internal combustion engine 11 as viewed along the front axle 12, the connecting shaft 33 being guided through a passage 35 which is provided in the oil sump 13. Like the drive shaft 20, the connecting shaft 33 is likewise configured as a hollow shaft, the right-hand lateral shaft 31 being guided through the hollow connecting shaft 33 and the hollow drive shaft 20. In the embodiment which is illustrated in FIG. 1, the front axle differential 23, the connecting shaft 33 and the electric machine 15 are therefore arranged coaxially.

The step-down gear mechanism 21A is capable of stepping down a rotation of the differential cage 25 of the front axle differential 23 relative to the rotor 19 of the electric machine 15. In accordance with FIG. 1, the step-down gear mechanism 21A has two stages and is divided into two single-stage planetary gear mechanisms 40, 41 which are arranged along the front axle 12 on opposed sides of the internal combustion engine 11. The first, electric machine-side planetary gear mechanism 40 is flange-connected directly onto an end side of the electric machine 15, the input taking place via a sun gear 45 which is formed directly on the drive shaft 20 of the electric machine 15. Planetary gears 49 which are mounted rotatably on a planetary carrier 47 mesh with the sun gear 45 and with a fixed internal gear 50, the planetary carrier 47, via which the output takes place, being coupled fixedly to the connecting shaft 33 so as to rotate with it. In the region of the front axle differential 23, a sun gear 60 of the second, differential-side planetary gear mechanism 41 is formed directly at one end of the connecting shaft 33 and meshes with planetary gears 61 which are mounted rotatably on a planetary carrier 65 and roll on a fixed internal gear 63. The planetary carrier 65 is configured in one piece with the differential cage 25 of the front axle differential 23 and represents the output of the second planetary gear mechanism 41. As a result, a rotational movement of the differential cage 25 relative to the rotor 19 of the electric machine 15 is stepped down by means of the two planetary gear mechanisms 40, 41 in two step-down stages which are connected one behind another.

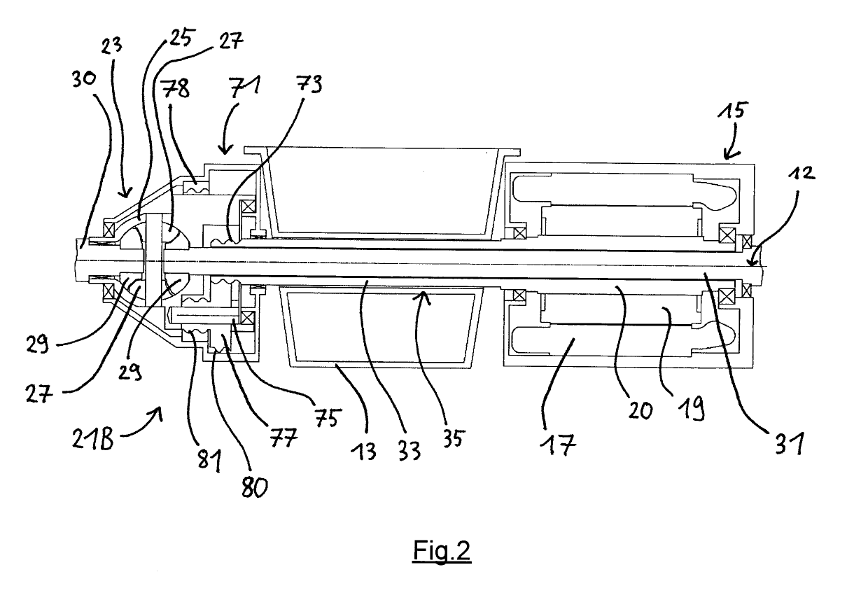

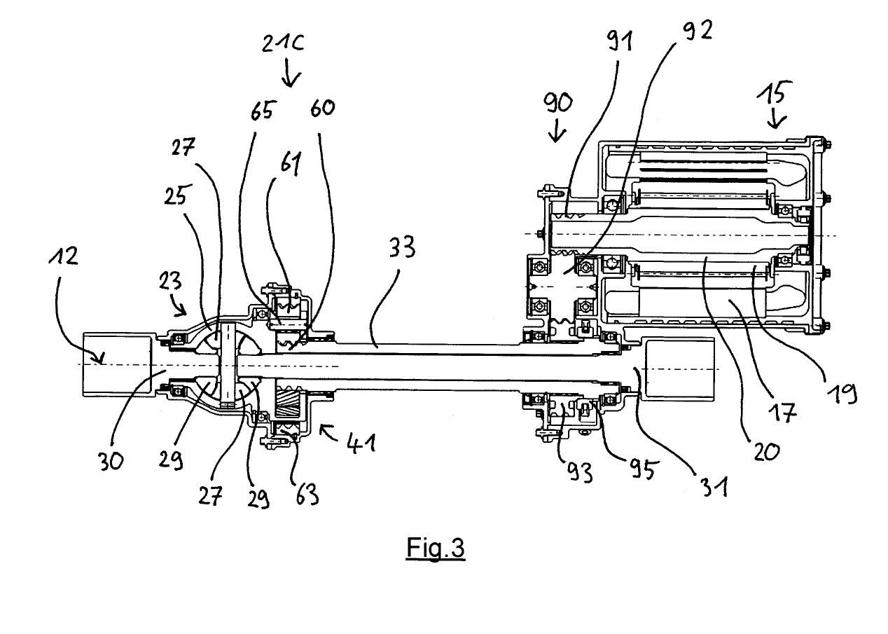

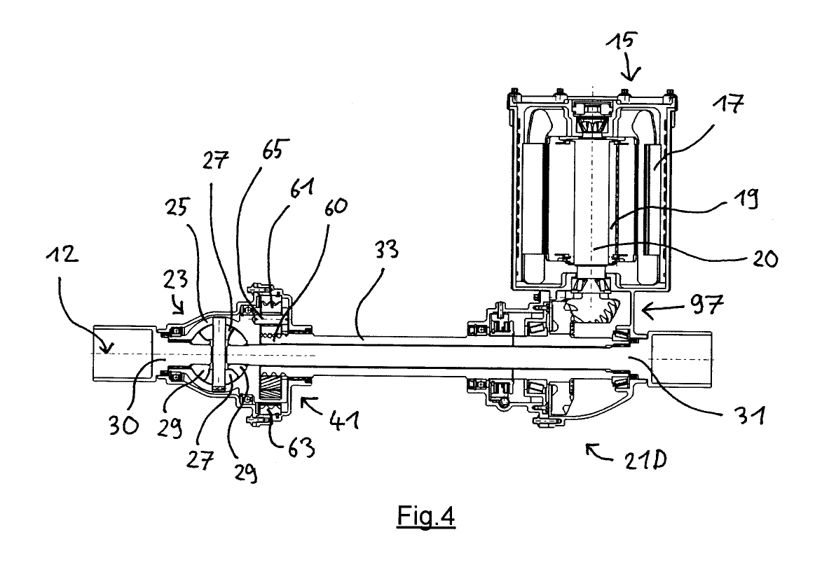

FIGS. 2 to 4 illustrate alternative embodiments of drive units in accordance with the invention, identical components being provided with the same designations as in the drive unit in accordance with FIG. 1. In the illustrations in accordance with FIGS. 3 and 4, the internal combustion engine and the oil sump are omitted for the sake of simplification.

In the refinement in accordance with FIG. 2, instead of two single-stage planetary gear mechanisms, the step-down gear mechanism 21B comprises a single multi-step planetary gear mechanism 71. The multi-step planetary gear mechanism 71 has a sun gear 73 which is formed directly on the connecting shaft 33, a fixed internal gear 78 and a planetary carrier 75 with a plurality of rotatably mounted planetary gears 77, the planetary gears 77 having a first toothing section 80 which meshes with the sun gear 73 and a second toothing section 81 which meshes with the internal gear 78. The first toothing section 80 has a greater diameter than the second toothing section 81, with the result that, in the case of an input via the sun gear 73 and an output by the planetary carrier 75, the multi-step planetary gear mechanism 71 provides a two-stage step-down transmission. Therefore, one planetary gear mechanism on the side of the electric machine 15 can in principle be omitted. In this embodiment, the drive shaft 20 of the electric machine 15 can be configured integrally, as illustrated, with the connecting shaft 33.

In the embodiment, illustrated in FIG. 3, of a drive unit in accordance with the invention, the drive shaft 20 of the electric machine 15 is offset in parallel relative to the connecting shaft 33, an offset drive 90 in the form of a spur gear set being provided for coupling the drive shaft 20 to the connecting shaft 33.

The offset drive 90 comprises an input spur gear 91 which is formed on the drive shaft 20, an intermediate spur gear 92 which meshes with the former, and an output spur gear 93 which meshes with the intermediate spur gear 92 and is coupled in drive terms to the connecting shaft 33. The offset drive 90 therefore forms a step-down stage of a step-down gear mechanism 21C, a single-stage differential-side planetary gear mechanism 41 forming a second step-down stage. A shiftable clutch 95 makes it possible to couple the output spur gear 93 of the offset drive 90 selectively to the connecting shaft 33. As a result, the electric machine 15 can be disengaged from the front axle differential 23 as required.

A separating clutch such as the shiftable clutch 95 can in principle also be provided in the remaining embodiments which are described.

In the embodiment, illustrated in FIG. 4, of a drive unit in accordance with the invention, the drive shaft 20 of the electric machine 15 is oriented at a right angle to the connecting shaft 33, a hypoid drive 97 being provided for coupling the drive shaft 20 to the connecting shaft 33. Like the offset drive 90 of the embodiment in accordance with FIG. 3, the hypoid drive 97 forms a step-down stage of a step-down gear mechanism 21D, whereas a second step-down stage is provided by a differential-side single-stage planetary gear mechanism 41.

In all the embodiments which are described, the step-down gear mechanism 21A, 21B, 21C, 21D is of two-stage configuration and thus makes a relatively high transmission ratio possible, with the result that the electric machine 15 can be operated at a comparatively high rotational speed and can therefore be of correspondingly small dimensions with a predefined power output.

### LIST OF REFERENCE SIGNS

11 Internal combustion engine
12 Front axle
13 Oil sump
15 Electric machine
17 Stator
19 Rotor
20 Drive shaft
21A, 21B, 21C, 21D Step-down gear mechanism
23 Front axle differential
25 Differential cage
27 Bevel gear
29 Bevel gear
30 Left-hand lateral shaft
31 Right-hand lateral shaft
33 Connecting shaft
35 Passage
40 First electric machine-side planetary gear mechanism
41 Second differential-side planetary gear mechanism
45 Sun gear of the first planetary gear mechanism
47 Planetary carrier of the first planetary gear mechanism
49 Planetary gear of the first planetary gear mechanism
50 Internal gear of the first planetary gear mechanism
60 Sun gear of the second planetary gear mechanism
61 Planetary gear of the second planetary gear mechanism
63 Internal gear of the second planetary gear mechanism
65 Planetary carrier of the second planetary gear mechanism
71 Multi-step planetary gear mechanism
73 Sun gear of the multi-step planetary gear mechanism
75 Planetary carrier of the multi-step planetary gear mechanism
77 Planetary gear of the multi-step planetary gear mechanism
Internal gear of the multi-step planetary gear mechanism
80 First toothing section
81 Second toothing section
90 Offset drive
91 Input spur gear
92 Intermediate spur gear
93 Output spur gear
95 Shiftable clutch
97 Hypoid drive

What is claimed is:

1. A drive unit for a hybrid vehicle which has a front axle and a rear axle, having an internal combustion engine, which is arranged in the region of the front axle, for driving at least the rear axle, an electric machine for driving the front axle, and a front axle differential which has an input member for receiving a drive power output from the electric machine, and two output members for coupling to a respective wheel of the front axle, the electric machine and the front axle differential being arranged along the front axle on opposed sides of the internal combustion engine, and the electric machine being coupled in drive terms to the input member of the front axle differential via a connecting shaft which is guided through an oil sump of the internal combustion engine.

2. The drive unit as claimed in claim 1, the connecting shaft being guided through a passage which is provided in the oil sump.

3. The drive unit as claimed in claim 1, the connecting shaft being configured as a hollow shaft, through which a lateral shaft is guided which leads from one of the output members of the front axle differential to the associated wheel of the front axle.

4. The drive unit as claimed in claim 1, the drive unit comprising a clutch for selectively disengaging the electric machine from the input member of the front axle differential.

5. The drive unit as claimed in claim 1, a drive shaft of the electric machine being arranged coaxially with respect to the connecting shaft and being configured, in particular, as a hollow shaft.

6. The drive unit as claimed in claim 1, the drive unit comprising an, in particular two-stage, step-down gear mechanism which is configured for stepping down a rotation of the input member of the front axle differential relative to a rotor of the electric machine.

7. The drive unit as claimed in claim 6, the step-down gear mechanism comprising at least one planetary gear mechanism which is, in particular, coaxial with respect to the connecting shaft and comprises a first member for coupling to the electric machine, a second member for coupling to the input member of the front axle differential and a third, fixed member.

8. The drive unit as claimed in claim 7, the planetary gear mechanism being arranged on that side of the internal combustion engine, on which the front axle differential is arranged.

9. The drive unit as claimed in claim 8, the second member of the planetary gear mechanism being configured in one piece with the input member of the front axle differential.

10. The drive unit as claimed in claim 7, the planetary gear mechanism comprising a sun gear, an internal gear and a planetary carrier with a plurality of rotatably mounted planetary gears, the planetary gears having a first toothing section which meshes with the sun gear and a second toothing section which meshes with the internal gear, the first toothing section having a greater diameter than the second toothing section.

11. The drive unit as claimed in claim 7, the step-down gear mechanism comprising two single-stage planetary gear mechanisms which are arranged on opposed sides of the internal combustion engine and forming respective step-down gear mechanisms which are connected one behind another.

12. The drive unit as claimed in claim 1, a drive shaft of the electric machine being offset in parallel relative to the connecting shaft, and an offset drive forming a step-down gear mechanism for coupling the drive shaft to the connecting shaft.

13. The drive unit as claimed in claim 12, the offset drive comprising a spur gear set with at least one input spur gear which is coupled or can be coupled to the electric machine and an output spur gear which is coupled or can be coupled to the connecting shaft.

14. The drive unit as claimed in claim 13, the input spur gear and the output spur gear of the offset drive meshing with at least one intermediate spur gear.

15. The drive unit as claimed in claim 13, the drive unit comprising a shiftable clutch, in order to couple the output spur gear of the offset drive selectively to the connecting shaft.

16. The drive unit as claimed in claim 1, a drive shaft of the electric machine being oriented at an angle which differs from 180° with respect to the connecting shaft, and an angle drive forming a step-down gear mechanism for coupling the drive shaft to the connecting shaft.
